(19) United States
(12) Patent Application Publication
(10) Pub. No.: US 2016/0251095 A1
(43) Pub. Date: Sep. 1, 2016

(54) Medicine Filling Apparatus

(71) Applicant: TAKAZONO TECHNOLOGY INCORPORATED, Hirakata-shi, Osaka (JP)

(72) Inventors: Makio Takahama, Hirakata-shi, Osaka (JP); Hirotsugu Kanemoto, Hirakata-shi, Osaka (JP)

(21) Appl. No.: 15/027,935

(22) PCT Filed: Oct. 9, 2013
(86) PCT No.: PCT/JP2013/077469

§ 371 Date: Apr. 7, 2016

(51) Int. Cl. B65B 1/10; B65B 57/20; B65B 39/00; B65B 57/14; A61J 7/00; B65B 1/30

(52) U.S. Cl. CPC B65B 1/10; A61J 7/0076; B65B 1/30; B65B 39/007; B65B 57/14; B65B 57/20

(57) ABSTRACT

Provided is a medicine filling apparatus used for filling a medicine container with solid medicines, including: a medicine housing unit configured to house the medicines and having a plurality of medicine outlets configured to eject the housed medicines; a rotor located within the medicine housing unit, having a plurality of temporary medicine housing units configured to temporarily house the medicines, and configured to move the medicines housed in the plurality of temporary medicine housing units to the plurality of medicine outlets by rotating; a medicine guide path configured to guide the medicines ejected from the plurality of medicine outlets to the medicine container; and a drive unit configured to rotationally drive the rotor.

### FIELD

The present invention relates to a medicine filling apparatus used for filling a medicine container with solid medicines.

### BACKGROUND

A pharmacist may provide a patient with solid medicines such as tablets according to a prescription by a doctor. In order to provide the patient with the medicines, the pharmacist may package the medicines separately by the type and amount of one-time dose (separate package) in some cases, or the pharmacist may fill a medicine container such as a vial container with the medicines collectively in other cases.

As an apparatus for filling a vial container with medicines, a tablet packing apparatus disclosed in JP H10-258801 A (Patent Literature 1), for example, can be mentioned. The tablet packing apparatus includes a tablet feeder capable of delivering tablets in an amount according to the prescription to the vial container. The tablet feeder includes a housing body that houses tablets, and a rotor rotatably located within the housing body. As the rotor rotates, the tablets can be sequentially ejected from an outlet provided in the housing body. The ejected tablets are delivered to the vial container after being counted by a tablet passage sensor provided in the tablet packing apparatus. In the configuration disclosed in Patent Literature 1, an outlet is provided at one point per unit of tablet feeder.

The vial container is filled with a lot of tablets. Therefore, in order to reduce the time required for filling operation, the rotor needs to rotate at high speed.

However, when the rotor rotates at high speed, there is a possibility of failure of filling in an exact quantity due to the tablets jamming within the tablet feeder or counting errors occurring in the tablet passage sensor.

JP H7-165202 A (Patent Literature 2) discloses providing outlets at two points for one unit of tablet feeder. However, in the configuration disclosed in Patent Literature 2, separate packing apparatuses are connected to the respective outlets. Therefore, in attempts to rotate the rotor at high speed for reducing the time required for filling operation, filling in an exact quantity may be failed due to the tablets jamming within the tablet feeder or counting errors occurring in the tablet passage sensor, like in the configuration of Patent Literature 1.

### CITATION LIST

### Patent Literature

Patent Literature 1: JP H10-258801 A

Patent Literature 2: JP H7-165202 A

### SUMMARY

### Technical Problem

It is therefore an object of the present invention to provide a medicine filling apparatus capable of reducing the time required for filling operation and filling a medicine container with medicines in an exact quantity.

### Solution to Problem

The present invention is a medicine filling apparatus used for filling a medicine container with solid medicines, including: a medicine housing unit configured to house the medicines and having a plurality of medicine outlets configured to eject the housed medicines; a rotor located within the medicine housing unit, having a plurality of temporary medicine housing units configured to temporarily house the medicines, and configured to move the medicines housed in the plurality of temporary medicine housing units to the plurality of medicine outlets by rotating; a medicine guide path configured to guide the medicines ejected from the plurality of medicine outlets to the medicine container; and a drive unit configured to rotationally drive the rotor.

Further, the medicine filling apparatus may further include an outlet cover provided for each of the plurality of medicine outlets except one medicine outlet and configured to be movable between a position to open the medicine outlet so that the medicines can be ejected and a position to close the medicine outlet so that the medicines cannot be ejected.

Further, the medicine filling apparatus may further include a detection unit configured to detect the medicines passing through the medicine guide path; and an outlet cover controlling unit configured to control the outlet cover to move based on detection signals of the detection unit, wherein the outlet cover controlling unit is configured to locate every outlet cover at the position to open the medicine outlet at the beginning of the start of filling the medicine container, and the outlet cover controlling unit is further configured to move every outlet cover to the position to close the medicine outlet, when the cumulative number of the medicines passing through the medicine guide path from the start of filling the medicine container has reached a specific number close to a designated number that has been designated in advance as the number of the medicines with which the medicine container is filled.

### BRIEF DESCRIPTION OF DRAWINGS

FIG. 1 is a vertical end face view in the width direction showing a medicine housing unit used for a medicine filling apparatus according to an embodiment of the present invention.

FIG. 2 is a vertical end face view in the depth direction showing the medicine housing unit used for the medicine filling apparatus.

FIG. 3 is a perspective view showing a rotor of the medicine filling apparatus.

FIG. 4 is a bottom view showing the medicine housing unit used for the medicine filling apparatus.

FIG. 5A is a schematic view showing the configuration of the medicine filling apparatus.

FIG. 5B is a block diagram of the medicine filling apparatus.

FIG. 6 is a schematic view showing the positional relationship of medicine housing recesses, medicine outlets, and an outlet cover of the rotor of the medicine housing unit used for the medicine filling apparatus.

FIG. 7 is a flowchart showing the control of the outlet cover.

### DESCRIPTION OF EMBODIMENT

Next, the present invention is described with reference to an embodiment of a medicine filling apparatus. The medicine filling apparatus includes a medicine cassette 1 as a medicine housing unit, a drive unit 2, a control unit 3, a medicine guide path 4, a medicine container arranging unit 5, and a medicine passage sensor 6 as a detection unit.

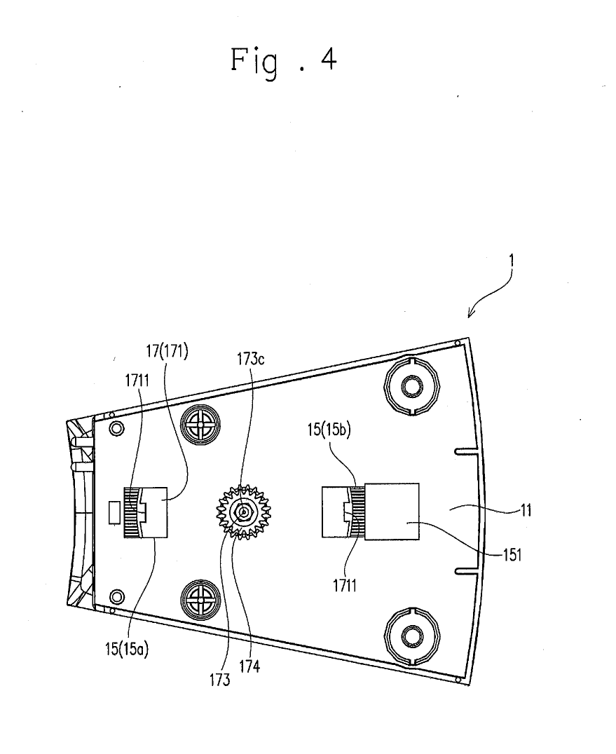

The medicine cassette 1, which corresponds to the tablet feeder disclosed in Patent Literatures 1 and 2 above, is in the form of a box made of resin or the like, and can house a plurality of tablets M and appropriately eject them. As shown in FIG. 4, the medicine cassette 1 of this embodiment is substantially trapezoidal, as viewed from the bottom. The medicine cassette 1 is replaceable on a base (not shown) provided in the body of the medicine filling apparatus. The medicine cassette 1 houses a single kind of tablets M.

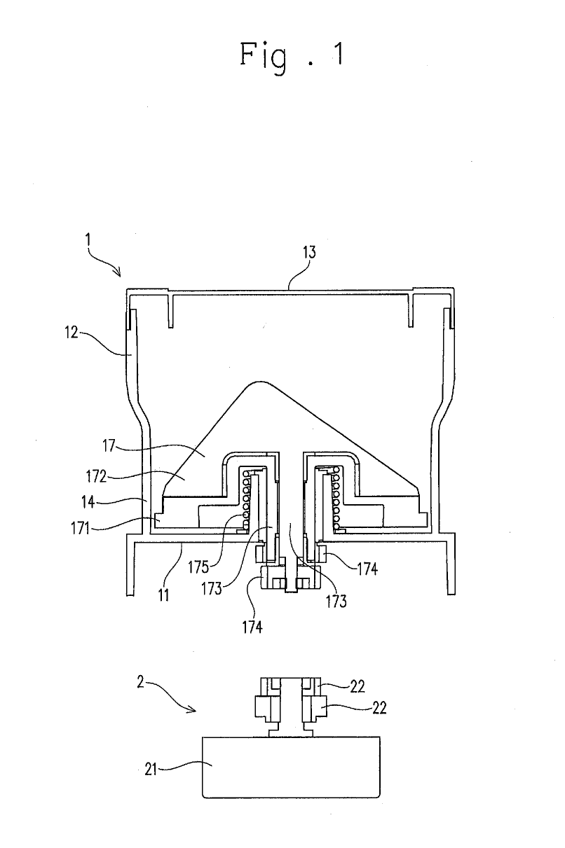

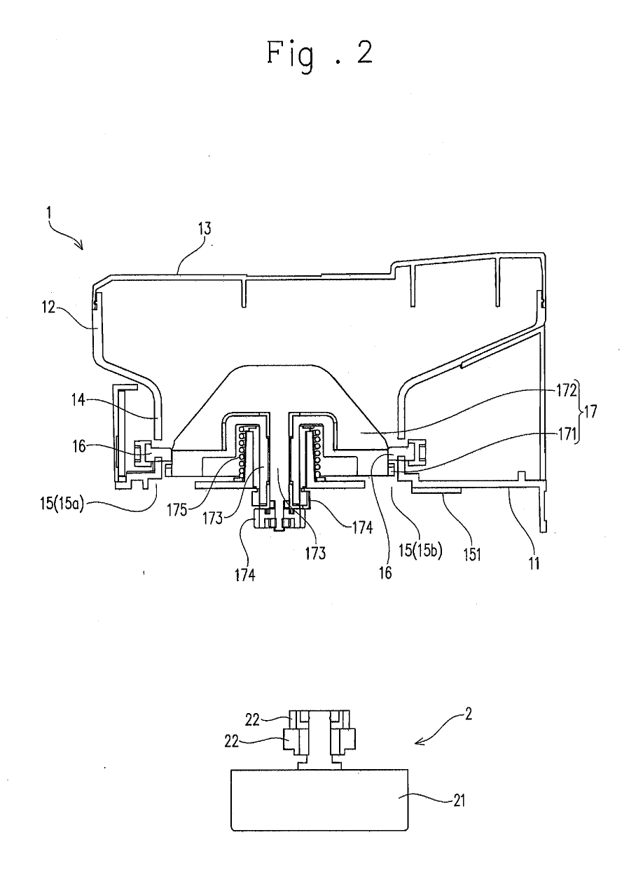

As shown in FIG. 1 and FIG. 2, the medicine cassette 1 has a bottom wall 11 and side walls 12 raised upward from the bottom wall 11, and a cover 13 is detachably attached onto the top of the side walls 12. Further, a cylindrical part 14 having an inner circumferential surface with a diameter slightly larger than the outer diameter of a lower disk part 171 of a rotor 17 is formed on the bottom wall 11. The rotor 17 is located inside the cylindrical part 14. One rotor 17 is provided in the medicine cassette 1 of this embodiment.

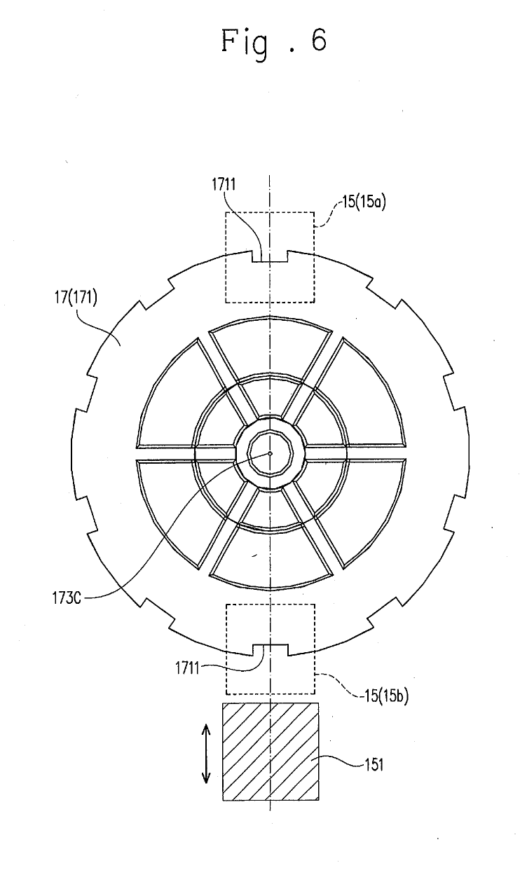

A plurality of medicine outlets 15 are formed in a portion on the bottom wall 11 that is surrounded by the cylindrical part 14, more specifically, a portion adjacent to the inner circumferential surface of the cylindrical part 14. As shown in FIG. 6, a first medicine outlet 15a and a second medicine outlet 15b serving as the medicine outlets 15 are formed at two points at equal intervals each making an angle of 180° with reference to a vertical axis 173C.

As shown in FIG. 2, a partition plate 16 extending in the horizontal direction is provided above each of the medicine outlets 15 so as to project in the radially inward direction from the inner circumferential surface of the cylindrical part 14. The partition plate 16 covers over the medicine outlet 15, thereby preventing two or more tablets M from falling into the medicine outlet 15 at a time. In the medicine cassette 1 of this embodiment, the medicine outlets 15 are formed at two points, and therefore partition plates 16 are also provided at two points.

Further, the rotor 17 configured to rotate about the vertical axis 173C (see FIG. 4) is provided on the bottom wall 11 of the medicine cassette 1. A rotation shaft 173 of the rotor 17 passes through the bottom wall 11. The rotation shaft 173 is provided with a driven gear 174 to which a driving force for rotationally driving the rotor 17 is transmitted from the drive unit 2 below the bottom wall 11. Further, the rotor 17 is biased upward by a spring 175.

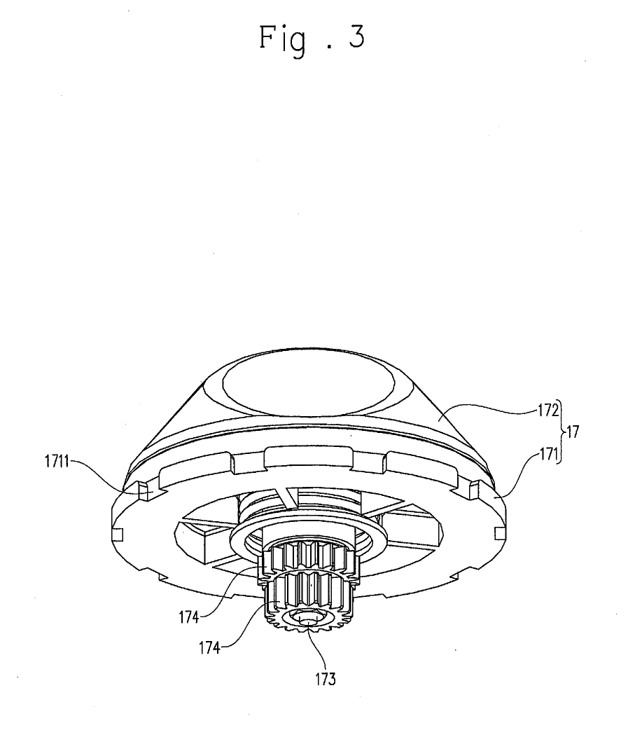

As shown in FIG. 3, the rotor 17 includes the lower disk part 171 and an upper bulging part 172. Although the lower disk part 171 and the upper bulging part 172 are separate and are configured to rotate separately in this embodiment, they may be integrated. In order to allow the lower disk part 171 and the upper bulging part 172 to rotate separately, the rotation shaft 173 includes inner and outer double shafts, and the driven gear 174 is provided for each shaft.

The upper bulging part 172 has a shape rising upward at a radially inward position and has a surface inclined toward a radially outward position. This shape allows the tablets M to slip down on the inclined surface, so that the tablets M housed in the medicine cassette 1 can be smoothly introduced downward. The lower disk part 171 has a substantially circular cross section, in which medicine housing recesses 1711 serving as temporary medicine housing units are formed along the rotation direction of the rotor 17 evenly at 10 points (at equal intervals at an angle of 36° with reference to the vertical axis 173C) so as to be recessed in the radially inward direction. Therefore, the plurality of medicine outlets 15 are formed along the rotation direction of the rotor 17 evenly at intervals different from those of the plurality of medicine housing recesses 1711. The number of the temporary medicine housing units 1711 formed (10 points) is larger than the number of the medicine outlets 15 formed (two points).

The tablets M are fitted into the respective medicine receiving recesses 1711. With such a state, the rotor 17 rotates. Therefore, the rotor 17 can rotate while the plurality of tablets M are temporarily housed in the medicine housing recesses 1711. Since the partition plates 16 prevent two or more tablets M from falling into the respective medicine outlets 15 at a time, the tablets M move (fall) into the respective medicine outlets 15 one by one, as the rotor 17 rotates with the tablets M being fitted into the medicine receiving recesses 1711. The relationship between the medicine housing recesses 1711 and the medicine outlets 15 will be described later.

The drive unit 2 is located in the base (not shown) provided in the body of the medicine filling apparatus. As shown in FIG. 1 and FIG. 2, the drive unit 2 includes a motor 21 as a driving source, and a drive gear 22 as a power transmission mechanism to which a driving force is transmitted from the motor 21. The drive gear 22 meshes with the driven gear 174 of the medicine cassette 1 when the medicine cassette 1 is attached to the body of the medicine filling apparatus. The drive unit 2 is controlled by the control unit so as to rotate the rotor 17 and stop the rotation. The medicines can be ejected from the medicine cassette 1 to the medicine guide path 4 by the drive unit 2.

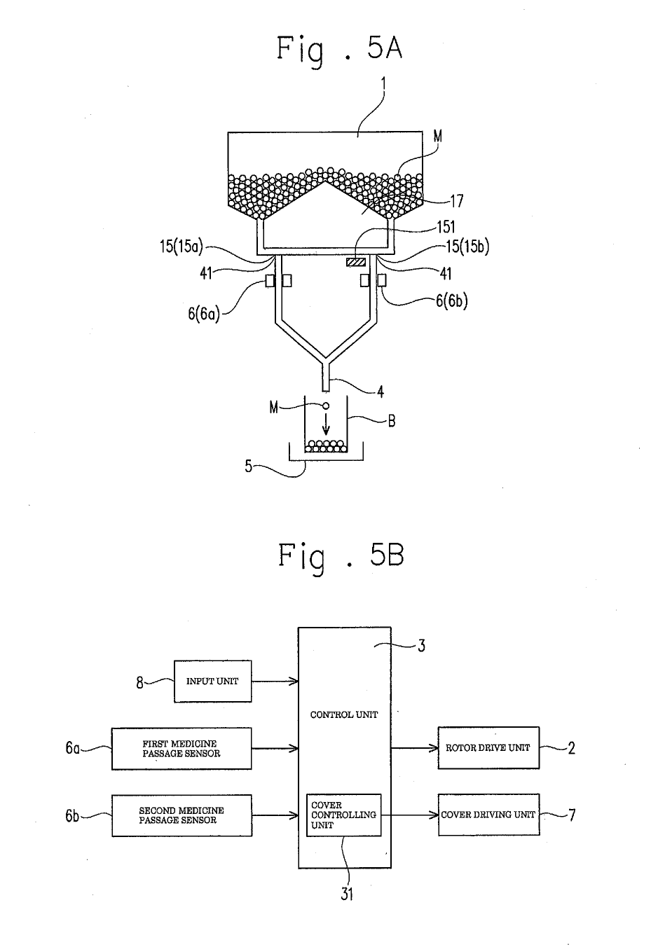

The medicine guide path 4 is located in the body of the medicine filling apparatus and is a path connecting the medicine outlets 15 (the first medicine outlet 15a and the second medicine outlet 15b) of the medicine cassette 1 to the medicine container arranging unit 5 in which a medicine container B such as a vial container is arranged, as shown in FIG. 5A. The medicines ejected from the medicine cassette 1 move to the opening of the medicine container B passing through the medicine guide path 4. The medicine guide path 4 has a plurality of inlets 41 (at two points) corresponding to the first medicine outlet 15a and the second medicine outlet 15b of the medicine housing unit. Further, an outlet 42 that is open into the medicine container B is provided at one point.

As shown in FIG. 5, a medicine passage sensor 6 serving as the detection unit configured to detect the tablets M passing therethrough is provided in a portion of the medicine guide path 4 located in the base (not shown) provided in the body of the medicine filling apparatus. The detection signals of the medicine passage sensor 6 are sent to the control unit 3 to be processed. A first medicine passage sensor 6a is provided corresponding to the first medicine outlet 15a, and a second medicine passage sensor 6b is provided corresponding to the second medicine outlet 15b. The medicine passage sensors 6 detect the tablets M ejected by the rotor 17 from the respective medicine outlets 15.

The medicine cassette 1 includes an outlet cover 151 that is one piece of plate at a position corresponding to the second medicine outlet 15b serving as one of the medicine outlets 15 at two points. Although not specifically described, the outlet cover 151 can move linearly along the bottom wall 11 between an opening position that does not overlap the second medicine outlet 15b and a closing position covering the second medicine outlet 15b by being driven by a cover driving unit 7. Therefore, the medicines can be ejected at the opening position, and the medicines cannot be ejected at the closing position. The cover driving unit 7 is controlled by a cover controlling unit 31 that is a part of the control unit 3.

In this embodiment, as described above, the second medicine outlet 15b can be opened and closed by the outlet cover 151. The control of the outlet cover 151 by the cover controlling unit 31 of the control unit 3 will be described below.

First, the outlet cover 151 is located at the opening position at the beginning of filling. Therefore, the tablets M can be ejected from the medicine outlets 15 at two points with one rotation of the rotor 17. Particularly in this embodiment, the medicine outlets 15 at two points and two of the medicine housing recesses 1711 that make an angle of 180° respectively overlap each other at the same time. Therefore, the tablets M can be ejected simultaneously from the medicine outlets 15 at two points. Since the medicine housing recesses 1711 are formed at 10 points in the lower disk part 171 of the rotor 17, 20 (10×2) tablets M are ejected from the medicine cassette 1 with one rotation of the rotor 17, calculationally. On the other hand, in a medicine housing unit (medicine cassette) provided with a medicine outlet at only one point, the tablets can be ejected only from the medicine outlet at one point with one rotation of the rotor. That is, 10 tablets are ejected from the medicine cassette 1 with one rotation of the rotor, if the lower disk part 171 is the same as in this embodiment. Therefore, in this embodiment, the tablets M can be ejected twice in the number calculationally even at the same rotational speed of the rotor 17, and thus high speed filling can be achieved at relatively low rotational speed. Accordingly, jamming of the tablets M within the medicine cassette 1 or the occurrence of counting errors by the medicine passage sensor 6 can be suppressed.

Next, in the case where the control unit 3 determines, based on the detection by the medicine passage sensor 6, that the cumulative number of the medicines passing through the medicine guide path 4 from the start of filling the medicine container B with the tablets M has reached a specific number close to the number that has been designated in advance by the input from an input unit 8 such as a touch panel or a ten key (the designated number) as the number of the tablets M with which the medicine container B is filled, the cover controlling unit 31 controls the cover driving unit 7 to close the second medicine outlet 15b so that the medicines cannot be ejected by moving the outlet cover 151 to the closing position. In this embodiment, the difference between the designated number and the specific number is set to 10, and when this difference is equal to or less than 10 (see step S18 below), the aforementioned control is performed. This control allows the tablets M to fall only from the medicine outlet 15 (the first medicine outlet 15a) at one point without falling simultaneously from the medicine outlets 15 at two points. Therefore, the tablets M are allowed to fall one by one, thus enabling error-free filling, for example, in the designated number corresponding to the prescribed dose. The control of rotating and stopping the rotation will be exemplified below.

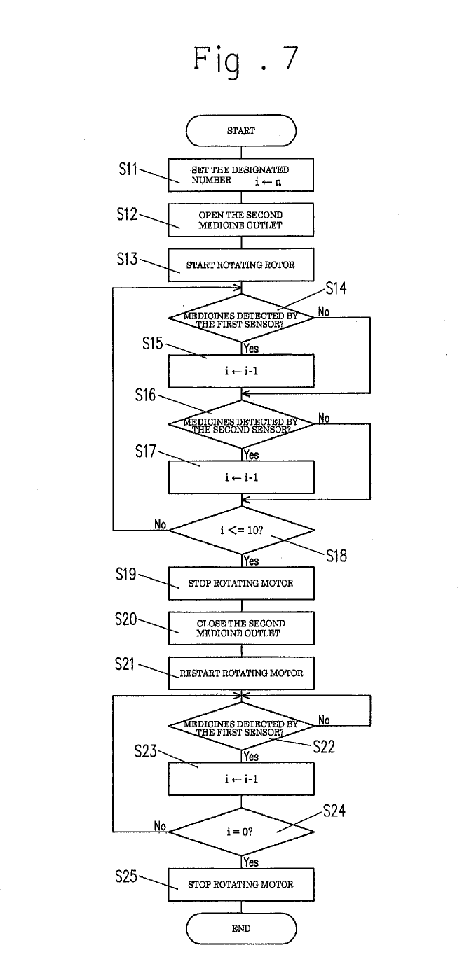

The process flow of the control will be described with reference to the flowchart. In the following determination, the subject of the determination is the control unit 3. First, as shown in FIG. 7, the designated number n is set to a variable i (step S11). Next, the second medicine outlet 15b is opened (step S12). Then, the motor 21 of the drive unit 2 starts rotating (step S13). Then, whether the first medicine passage sensor 6a has detected the medicines passing through the medicine guide path 4 is determined (step S14). If YES is determined, the variable i is reduced by one (step S15), and the process proceeds to step S16. If NO is determined, whether the second medicine passage sensor 6b has detected the medicines passing through the medicine guide path 4 is determined (step S16). If YES is determined, the variable i is reduced by one (step S17), and the process proceeds to step S18. If NO is determined, whether the variable i is equal to or less than 10 (in the case where the difference between the designated number and the specific number is set to 10) is determined (step S18). If YES is determined, the motor 21 stops rotating (step S19). If NO is determined, the process returns to step S14.

Next, the second medicine outlet 15b is closed (step S20), and the motor 21 starts (restarts) rotating (step S21). Then, whether the first medicine passage sensor 6a has detected the medicines passing through the medicine guide path 4 is determined (step S22). If YES is determined, the variable i is reduced by one (step S23). If NO is determined, step S22 is repeated. Next, whether the variable i is 0 is determined (step S24). If YES is determined, the motor 21 stops rotating (step S25). If NO is determined, the process returns to step S22.

Hereinbefore, an embodiment of the present invention has been described. However, the present invention is not limited to the above described embodiment, and various modifications can be made without departing from the gist of the present invention.

For example, the medicines serving as objects with which the medicine container B is filled are not limited to tablets, and the present invention can be applied generally to solid medicines such as capsules. Further, the medicines are not limited to the prescription medicines and may be medicines that do not need a prescription by a doctor. Further, the “medicines” are not limited to those having medicinal properties and include solid nutritional supplements (supplements), for example. Further, the numbers of the medicine outlets 15 and the temporary medicine housing units 1711 to be formed are not limited to those in this embodiment (two points of the medicine outlets 15 and 10 points of the temporary medicine housing units 1711), and various numbers of them can be formed. The number of the medicine outlets 15 formed can be optionally selected, for example, within the range of 2 points to 4 points. The number of the medicine housing recesses 1711 formed can be optionally selected, for example, within the range of 5 points to 15 points. Further, the medicine outlets 15 are not limited to those formed at equal intervals as in this embodiment, and they can be formed at unequal intervals. Further, the configuration may be such that the temporary medicine housing units 1711 do not coincide with the medicine outlets 15 simultaneously at two or more points so that the medicines can be ejected. Further, the outlet cover 151 is not limited to one piece of plate, and can be composed of two or more pieces of plates. Further, the outlet cover 151 is not limited to one that is movable linearly along the bottom wall 11, and can be one pivotable along the bottom wall 11 or one pivotable about the center of the pivot axis along the bottom wall 11. Further, the detection unit (medicine passage sensor) 6 needs only to be capable of detecting the medicines passing through the medicine guide path 4, and is not limited to being provided in the medicine guide path 4. For example, the detection unit 6 can be provided in the medicine cassette 1. Further, one unit of the medicine cassette 1 can include two or more rotors 17. Further, a plurality of medicine cassettes 1 can be attached to the body of the medicine filling apparatus. In this case, a plurality of inlets 41 of the medicine guide path 4 are located corresponding to the plurality of medicine cassettes 1. The lines of the medicine guide path 4 merge in the middle, and the outlet 42 that is open into the medicine container B is located at one point. However, for the purpose of contamination prevention or the like, it is possible that not all the lines of the medicine guide path 4 merge in the middle, and outlets 42 are provided at two or more points in the medicine guide path 4.

Finally, the configuration and action of this embodiment will be summarized. This embodiment is a medicine filling apparatus used for filling the medicine container B with solid medicines (tablets) M, the apparatus including: a medicine housing unit (medicine cassette) 1 configured to house the medicines (tablets) M and having a plurality of medicine outlets 15a and 15b configured to eject the housed medicines (tablets) M; a rotor 17 located within the medicine housing unit (medicine cassette) 1, having a plurality of temporary medicine housing units (medicine housing recesses) 1711 configured to temporarily house the medicines (tablets) M, and configured to move the medicines (tablets) M housed in the plurality of temporary medicine housing units (medicine housing recesses) 1711 to the plurality of medicine outlets 15a and 15b by rotating; a medicine guide path 4 configured to guide the medicines (tablets) M ejected from the plurality of medicine outlets 15a and 15b to the medicine container B; and a drive unit 2 configured to rotationally drive the rotor 17.

According to this configuration, the medicine housing unit (medicine cassette) 1 has the plurality of medicine outlets 15a and 15b. In this configuration, the medicines (tablets) M can be ejected from the plurality of medicine outlets 15a and 15b with one rotation of the rotor 17. On the other hand, in a medicine housing unit (medicine cassette) provided with a medicine outlet only at one point, the medicines (tablets) M can be ejected only from the medicine outlet at one point with one rotation of the rotor 17. Therefore, in this embodiment, high speed filling can be achieved at relatively low rotational speed.

Further, an outlet cover 151 that is movable between a position to open the medicine outlet (the second medicine outlet) 15b so that the medicines can be ejected and a position to close the medicine outlet (the second medicine outlet) 15b so that the medicines cannot be ejected can be further provided for the medicine outlet (the second medicine outlet) 15b that is one of the plurality of medicine outlets 15a and 15b except one (the second medicine outlet 15a).

According to this configuration, the outlet cover 151 is movable between the position to open the medicine outlet (the second medicine outlet) 15b so that the medicines can be ejected and the position to close the medicine outlet (the second medicine outlet) 15b so that the medicines cannot be ejected. Therefore, in the state where the medicines cannot be ejected, the medicines (tablets) M are not ejected simultaneously from the plurality of medicine outlets 15a and 15b, and the medicines (tablets) M are ejected only from the medicine outlet (the second medicine outlet) 15b at one point. Therefore, the medicines (tablets) M can be reliably counted one by one. Accordingly, jamming of the medicines (tablets) M within the medicine housing unit (medicine cassette) 1 or the occurrence of counting errors by the medicine passage sensor 6 can be suppressed.

Further, the medicine filling apparatus may further include: a detection unit configured to detect the medicines (tablets) M passing through the medicine guide path 4; and an outlet cover controlling unit 31 configured to control the outlet cover 151 to move based on detection signals of the detection unit, wherein the outlet cover controlling unit 31 is configured to locate every outlet cover 151 at the position to open the medicine outlet (the second medicine outlet) 15b at the beginning of the start of filling the medicine container B, and the outlet cover controlling unit 31 is further configured to move every outlet cover 151 to the position to close the medicine outlet (the second medicine outlet) 15b, when the cumulative number of the medicines passing through the medicine guide path 4 from the start of filling the medicine container B has reached a specific number close to a designated number that has been designated in advance as the number of the medicines (tablets) M with which the medicine container B is filled.

As described above, in the medicine filling apparatus according to this embodiment, high-speed filling at relatively low rotational speed is enabled, and therefore jamming of the medicines (tablets) M within the medicine housing unit (medicine cassette) 1 or the occurrence of counting errors by the medicine passage sensor 6 can be suppressed. Therefore, the time required for filling operation can be reduced, and the medicine container B can be filled with the medicines (tablets) M in an exact quantity.

### REFERENCE SIGNS LIST

1: Medicine housing unit, Medicine cassette
15: Medicine outlet
151: Outlet cover
17: Rotor
1711: Temporary medicine housing unit, Medicine housing recess
2: Drive unit
3: Control unit
31: Outlet cover controlling unit
4: Medicine guide path
B: Medicine container
M: Medicines, Tablets

1. A medicine filling apparatus used for filling a medicine container with solid medicines, comprising:
a medicine housing unit configured to house the medicines and having a plurality of medicine outlets configured to eject the housed medicines;
a rotor located within the medicine housing unit, having a plurality of temporary medicine housing units configured to temporarily house the medicines, and configured to move the medicines housed in the plurality of temporary medicine housing units to the plurality of medicine outlets by rotating;
a medicine guide path configured to guide the medicines ejected from the plurality of medicine outlets to the medicine container; and
a drive unit configured to rotationally drive the rotor.

2. The medicine filling apparatus according to claim 1, further comprising:
an outlet cover provided for each of the plurality of medicine outlets except one medicine outlet and configured to be movable between a position to open the medicine outlet so that the medicines can be ejected and a position to close the medicine outlet so that the medicines cannot be ejected.

3. The medicine filling apparatus according to claim 2, further comprising:
a detection unit configured to detect the medicines passing through the medicine guide path; and
an outlet cover controlling unit configured to control the outlet cover to move based on detection signals of the detection unit, wherein
the outlet cover controlling unit is configured to locate every outlet cover at the position to open the medicine outlet at the beginning of the start of filling the medicine container, and
the outlet cover controlling unit is further configured to move every outlet cover to the position to close the medicine outlet, when the cumulative number of the medicines passing through the medicine guide path from the start of filling the medicine container has reached a specific number close to a designated number that has been designated in advance as the number of the medicines with which the medicine container is filled.
